(19) United States
(12) Patent Application Publication
(10) Pub. No.: US 2007/0258386 A1
(43) Pub. Date: Nov. 8, 2007

(54) ZIGBEE NETWORK SYSTEM, METHOD WITH ROAMING FUNCTION, AND COMPUTER READABLE MEDIUM THEREOF

(75) Inventors: Yung-Chih Liu, Taipei (TW); Bing-Huan Shie, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/428,652

(22) Filed: Jul. 5, 2006

(30) Foreign Application Priority Data
May 3, 2006 (TW) 095115787

(51) Int. Cl. H04L 12/28

(52) U.S. Cl. 370/254; 370/352; 370/395.53

(57) ABSTRACT

A ZigBee network system, method with roaming function, and computer readable medium thereof are provided. The ZigBee network system comprises a first node, a second node, a coordinator and a first roaming node. The first node, the second node and the coordinator are connected directly or indirectly. The first roaming node connects to the first node wirelessly. The method comprises the following steps. The first roaming node transmits a roaming-request packet when the first roaming node roams within a connecting range of the second node. The second node transmits a roaming-identify packet in response to the roaming-request packet. One of the first node and the coordinator transmits a roaming-confirm packet in response to the roaming-request packet. The second node transmits a roaming-response packet in response to the roaming-confirm packet. The first roaming node connects to the second node wirelessly after the first roaming node receives the roaming-response packet.

### CROSS-REFERENCES TO RELATED APPLICATIONS

This application claims the benefit of priority based on Taiwan Patent Application No. 095115787 filed on May 3, 2006.

### BACKGROUND OF THE INVENTION

1. Field of the Invention

The present invention relates to a ZigBee network system, method, and computer readable medium thereof; more specifically, relates to a ZigBee network system, method, and computer readable medium for performing roaming function by automatically adjusting a network address of an end device.

2. Descriptions of the Related Art

ZigBee is a very novel short distance transmitting technical standard which is designed to satisfy requirements of the wireless network with the low data rate, low power consumption, and low cost. The ZigBee Alliance, which is established in 2002, defines the ZigBee wireless communication standard with the simple structure, low cost, and easy achievement base on IEEE 802.15.4 wireless standard in the main application fields of sensing and controlling.

The FIG. 1 shows a structure of a ZigBee personal area network (PAN). The ZigBee PAN comprises a coordinator 101, a plurality of routers, and a plurality of end devices 105. The coordinator 101 is used to establishe a ZigBee PAN and the coordinator 101 further comprises a routing table which records paths of routing data packets and a binding table which records network addresses of each router 103 and each end device 105. Next, the router 103 comprises a connecting range 107, each end device 105 in the connecting range 107 connects to the router 103 wirelessly. The router 103 comprises a routing table and a neighbor table, while the neighbor table records network addresses of each end device 105 which connects to the router 103. The routing table, the same as that of the coordinator 101, records paths of routing data packets. The end device 105 comprises a transmitting node and a receiving node. The former is used to transmit data, that is to transfer data to data packets and to transmit them to the router 103. The later is used to receive data, that is to receive data packets from the router 103. It is noted that the end device 105 does not have the function of routing data packets.

The ZigBee network comprises two communication standards that are instituted by different organizations. One of the standards is the ZigBee standard, which is guided by the ZigBee Alliance, defines the network layer, the security layer, and the application layer. The other one is the 802.15.4 standard, which is guided by the Institute of Electrical and Electronics Engineers (IEEE), defines the physical (PHY) layer and the medium access control (MAC) layer.

Based on IEEE 802.15.4, the ZigBee Alliance defines specifications of the network layer, the security layer, and the application layer. The network layer establishes and manages the network institutions, and has functions of self configure and self healing. In the network layer, the ZigBee standard defines functions of the aforesaid coordinators, routers, and end devices. The coordinator is used to establish a ZigBee PAN and distributes network addresses. The router is used to search, establish, and repair routing paths of data packets and to route data packets. The end device can only join the ZigBee PAN which has been established and is able to transmit data but cannot route the packets.

The application layer of the ZigBee IEEE 802.15.4 standard contains concepts of service. For a ZigBee apparatus, when it joins a ZigBee PAN, the application layer executes a sequence of initial steps. First, the application layer executes a step of device discovery and a step of service discovery, and then, records related network addresses of end devices, related network addresses of routers, or services in the binding table of the coordinator. After that, all services should refer to the information of end devices or routers according to the binding table. In addition, the security layer defines an algorithm of encryption and decryption, setups of keys, and many mechanisms of security management as well.

In the above-mentioned ZigBee PAN, the router and the end device are usually connected via a predetermined connecting process procedure based on consideration of security management. The connecting process procedure of the prior art usually has a complex policy, or needs personal processing. For example, both of the router and the end device have to press connecting buttons to avoid joining and connecting to a ZigBee PAN established by other coordinators, and avoid end devices of other ZigBee PAN joining and connecting thereto.

Next, in the ZigBee PAN, each end device is predetermined in a fixed position. However, the end devices often have a need to be moved on actual applications, such as a remote control acted as an end device. More specifically, if a connected end device is moved to a position beyond the connecting range of the original connecting router, it has to re-establish connection with the ZigBee PAN. The connecting processing procedure becomes extraordinary difficult because the policy thereof such as the mechanisms of security management should be considered. Meanwhile, network addresses of each end device and each router are determined by the network layer, which means that the end devices would use new network addresses when re-establishing so that the original connection which has been established fails to transmit or route data packets smoothly.

Owing to the present ZigBee PAN only provides an orphan-join function at the MAC layer, the end device can just reconnect to the original router with the orphan-join function, and unable to move to other routers and establish new connections. Accordingly, a solution to solve the aforesaid problem that the end device cannot re-establish connection with other new routers smoothly when moving, and change the routing path of data packets when the original network address of the end device is replaced by a new network address is desired in the industrial field.

### SUMMARY OF THE INVENTION

One object of this invention is to provide a ZigBee network system with roaming function. The ZigBee network system comprises a first node, a second node, a coordinator, and a first roaming node. The coordinator connects to the first node and the second node directly or indirectly. The first roaming node connects to the first node wirelessly, and transmits a roaming-request packet to the second node when the first roaming node roams within a connecting range of the second node. The second node transmits a roaming-identify packet to the first node and the coordinator in response to the roaming-request packet. When one of the first node and the coordinator transmits a roaming-confirm packet to the second node, the second node transmits a roaming-response packet to the first roaming node in response to the roaming-confirm packet. The first roaming node connects to the second node wirelessly after the first roaming node receives the roaming-response packet.

Another object of this invention is to provide a method for performing roaming function in a ZigBee network system, wherein the ZigBee network system comprises a first node, a second node, a coordinator, and a first roaming node. The first roaming node is connected to the first node wirelessly. The first node and the second node are connected directly or indirectly to the coordinator. The method comprising the following steps: transmitting a roaming-request packet to the second node when the first roaming node roams within a connecting range of the second node; transmitting a roaming-identify packet to the first node and the coordinator in response to the roaming-request packet; transmitting a roaming-confirm packet to the second node by the first node and the coordinator; transmitting a roaming-response packet to the first roaming node by the second node in response to the roaming-confirm packet; and connecting to the second node after the first roaming node receives the roaming-response packet.

Another object of this invention is to provide a computer program product for storing a computer program, which executes the aforementioned method.

Another object of this invention is to provide a router for using in a ZigBee network system with roaming function, wherein the ZigBee network system comprises a roaming node and a coordinator. The router connects to the coordinator. When the roaming node roams within a connecting range of the router, the router receives a roaming-request packet transmitted from the roaming node, and transmits a roaming-identify packet to the coordinator in response to the roaming-request packet. When the coordinator transmits a roaming-confirm packet to the router in response to the roaming-identify packet, the router transmits a roaming-response packet to the roaming node in response to the roaming-confirm packet and connects to the roaming node wirelessly.

Another object of this invention is to provide an end device for using in a ZigBee network system with roaming function, wherein the ZigBee network system comprises a router and a coordinator. The router connects to the coordinator. When the end device roams within a connecting range of the router, the end device transmits a roaming-request packet to the router, and the router transmits a roaming-identify packet to the coordinator in response to the roaming-request packet. When the coordinator transmits a roaming-confirm packet to the router in response to the roaming-identify packet, the end device receives a roaming-response packet transmitted in response to the roaming-confirm packet from the router and connects to the router wirelessly.

The present invention provides a roaming service in a ZigBee network by the network layer, and provides a new roaming procedure on the primitive coordinator, router, and end device. After the end device disconnects from the primitive router which connects to the end device, the end device can reconnect to other routers of the same ZigBee network successfully, and redefine routing paths of data packets automatically to solve the prior problem that the data packets cannot route successfully.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a diagram of a ZigBee network system of the prior art;

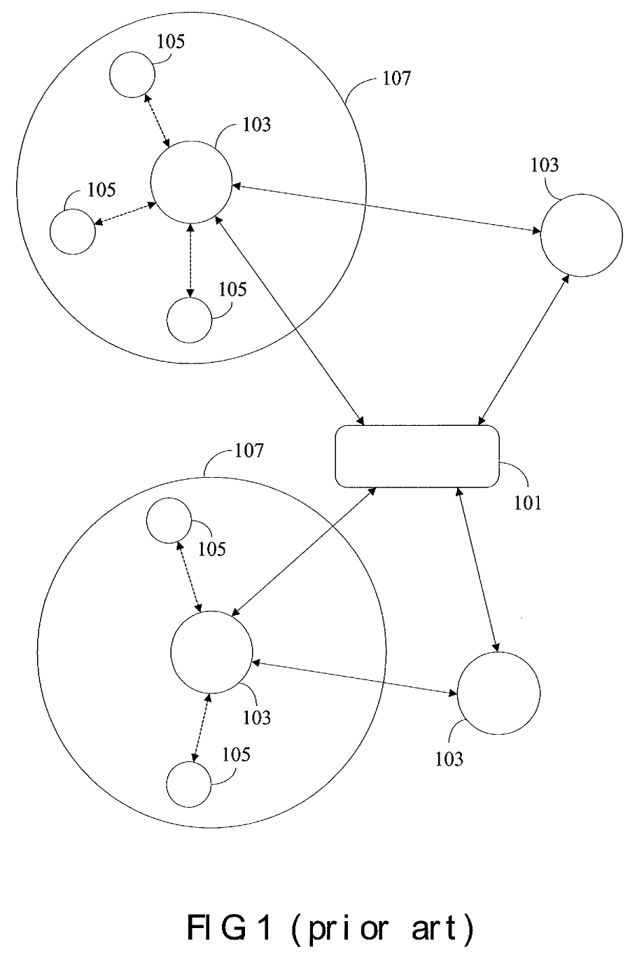

FIG. 2 is a diagram of a first embodiment of the present invention;

FIG. 3 is a diagram of packets transmitting sequence of the first embodiment;

FIG. 4 is a flow chart of a second embodiment of the present invention;

FIG. 5 is a flow chart of modifying network addresses of the second embodiment;

FIG. 6 is a flow chart of responding to a roaming-identify packet of the second embodiment; and

FIG. 7 is another flow chart of the second embodiment.

### DESCRIPTION OF THE PREFERRED EMBODIMENT

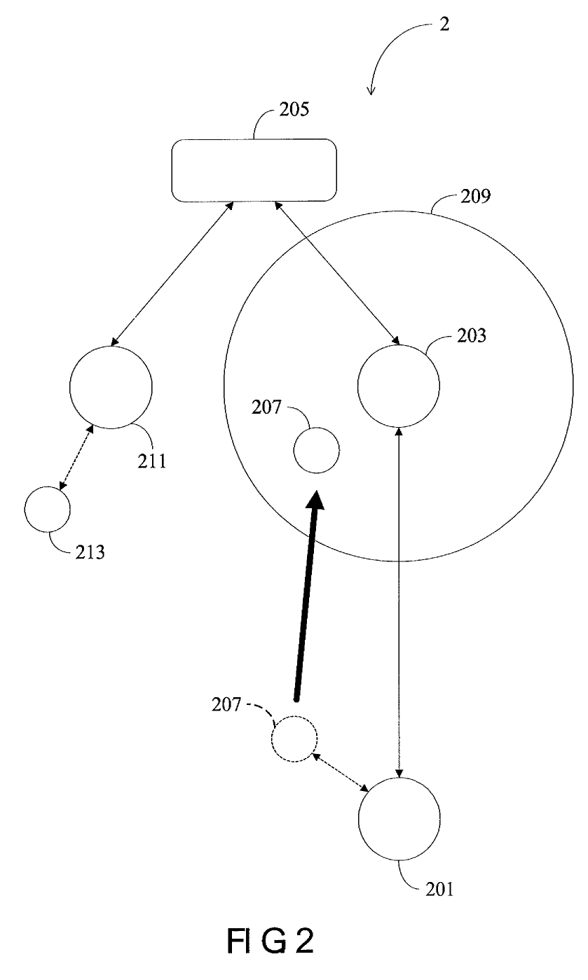

A first embodiment of the present invention is a ZigBee network system 2 with roaming function. As shown in FIG. 2, the ZigBee network system 2 comprises a first node 201, a second node 203, a third node 211, a first roaming node 207, a second roaming node 213, and a coordinator 205. The first node 201, the second node 203, and the third node 211 are connected to the coordinator 205 directly or indirectly.

In this embodiment, the first node 201, the second node 203, and the third node 211 are routers that are defined by the ZigBee standard. The first roaming node 207 and the second roaming node 213 are end devices that are defined by the ZigBee standard. Furthermore, the first roaming node 207 originally connects to the first node 201 wirelessly. When the first roaming node 207 roams within a connecting range 209 of the second node 203, the ZigBee network system 2 has to execute a sequence of connecting procedures for establishing a new connection with the second node 203, wherein the connecting range 209 of the second node 203 is determined by the performance of the second node 203.

As mentioned above, the first node 201 further comprises a first routing table and a first neighbor table. The second node 203 comprises a second routing table and a second neighbor table. The coordinator 205 comprises a coordinate routing table, and may also comprise a binding table simultaneously. When the first roaming node 207 connects to the first node 201 wirelessly, the first node 201 sets a first network address to the first roaming node 207. The first network address is stored in the first routing table, the first neighbor table, the second routing table, and the coordinate routing table. If the coordinator 205 comprises a binding table, the first network address is also stored in the binding table to confirm a connecting status of the first roaming node 207 and the first node 201.

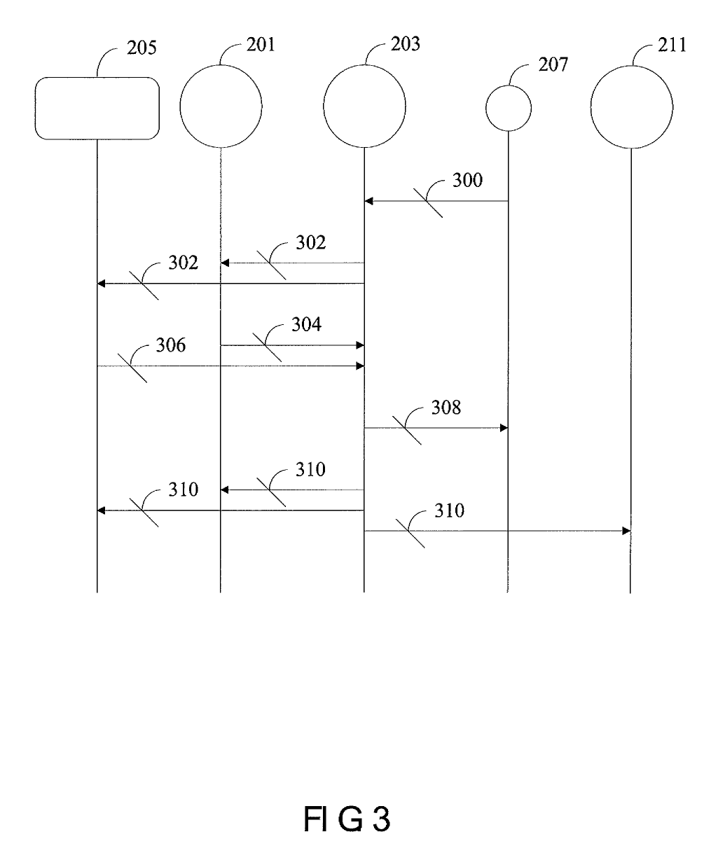

As shown in FIG. 3, the ZigBee network system 2 executes a sequence of connecting procedures when the first roaming node 207 roams within the connecting range 209 of the second node 203. First, the first roaming node 207 transmits a roaming-request packet 300 to the second node 203. The second node 203 simultaneously transmits a roaming-identify packet 302 to the first node 201 and the coordinator 205 in response to the roaming-request packet 300. When the first node 201 receives the roaming-identify packet 302, it examines whether the first network address is stored in the first neighbor table. If the first network address is stored in the first neighbor table, the first node 201 transmits a roaming-confirm packet 304 to the second node 203. Secondly, when the coordinator 205 that comprises the binding table receives the roaming-identify packet 302, the coordinator 205 examines whether the first network address is stored in the binding table. If the first network address is stored in the binding table, the coordinator 205 also transmits a roaming-confirm packet 306 to the second node 203. If the coordinator 205 does not comprise the binding table, or the first network address is not stored in the binding table, the coordinator 205 ignores the roaming-identify packet 302.

The second node 203 transmits a roaming-response packet 308 to the first roaming node 207 on condition that the second node 203 receives one of the roaming-confirm packet 304 transmitted by the first node 201 and the roaming-confirm packet 306 transmitted by the coordinator 205 to confirm that the first roaming node 207 is a member of the ZigBee network system 2. The first roaming node 207 can wirelessly reconnect to the second node 203 of the ZigBee network system 2 in response to the roaming-response packet 308.

After the first roaming node 207 connects to the second node 203 successfully, the second node 203 sets a second network address to the first roaming node 207, stores the second network address in the second neighbor table, and replaces the first network address stored in the second routing table by the second network address. At the same time, the second node 203 broadcasts a service-change packet 310. The first routing table of the first node 201 and the coordinate routing table of the coordinator 205 are separately updated in response to the service-change packet 310. The coordinator 205 also updates the binding table if the coordinator 205 comprises the binding table.

More specifically, the first network addresses stored in the first node 201 and the coordinator 205 are replaced by the second network address separately to update a connecting status of the first roaming node 207 and the second node 203. And the first roaming node 207 does not connect to the first node 201 on the moment. Then the first node 201 will delete the first network address stored in the first neighbor table. The first roaming node 207 performs the roaming procedure of roaming to the second node 203 of the ZigBee network system 2 via the sequence of connecting procedures of packets transmission.

Accordingly, if the first roaming node 207 does not receive the roaming-response packet 308 transmitted from the second node 203 after a predetermined time (10 second from the ZigBee standard), the first roaming node 207 retransmits a roaming-request packet 300 for re-executing the sequence of connecting procedures to reconnect to the ZigBee network system 2.

In the ZigBee network system 2 of the first embodiment, the third node 211 further comprises a third routing table and a third neighbor table. The second roaming node 213 connects to the third node 211 wirelessly. The third node 211 sets a third network address to the second roaming node 213, and the third network address is stored in the first routing table, the second routing table, the third routing table, the third neighbor table, and the coordinate routing table. The third network address is also stored in the binding table if the coordinator 205 comprises the binding table. When the first roaming node 207 connects to the first node 201 wirelessly, the first network address is stored in the third routing table of the third node 211. After the first roaming node 207 connects to the second node 203 successfully, the third node 211 receives the service-change packet 310. At the same time, the third node 211 replaces the first network address stored in the third routing table by the second network address to update the connecting status of the first roaming node 207 and the second node 203 in response to the service-change packet 310.

The roaming-request packet 300, the roaming-identify packet 302, the roaming-confirm packet 304, 306, the roaming-response packet 308, and the service-change packet 310 of the ZigBee network system 2 of the first embodiment are transmitted via the network layer that is defined by the ZigBee standard. The reconnecting function of the ZigBee network system 2 that is executed by the network layer is different form the orphan-join function of the ZigBee network system of the prior art that is executed by the MAC layer.

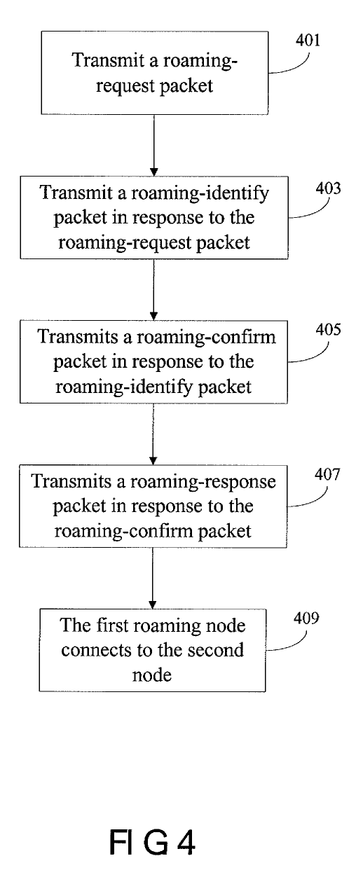

A second embodiment of the present invention is a method for performing roaming function in a ZigBee network system. The ZigBee network system, as the same with the ZigBee network system 2 of the first embodiment, comprises a first node, a second node, a coordinator, and a first roaming node. The first roaming node initially connects to the first node wirelessly. The first node and the second node are connected directly or indirectly. The method is shown in FIG. 4.

As shown in FIG. 4, the method comprises the following steps. In step 401, the first roaming node transmits a roaming-request packet to the second node when the first roaming node roams within a connecting range of the second node. In step 403, the second node transmits a roaming-identify packet to the first node and the coordinator in response to the roaming-request packet. In step 405, one of the first node and the coordinator transmits a roaming-confirm packet to the second node in response to the roaming-identify packet. In step 407, the second node transmits a roaming-response packet to the first roaming node in response to the roaming-confirm packet. In step 409, the first roaming node connects to the second node after the first roaming node receives the roaming-response packet.

In the method of the second embodiment, the first node further comprises a first routing table and a first neighbor table. The second node further comprises a second routing table and second neighbor table. The coordinator further comprises a coordinate routing table, and may also comprise a binding table simultaneously.

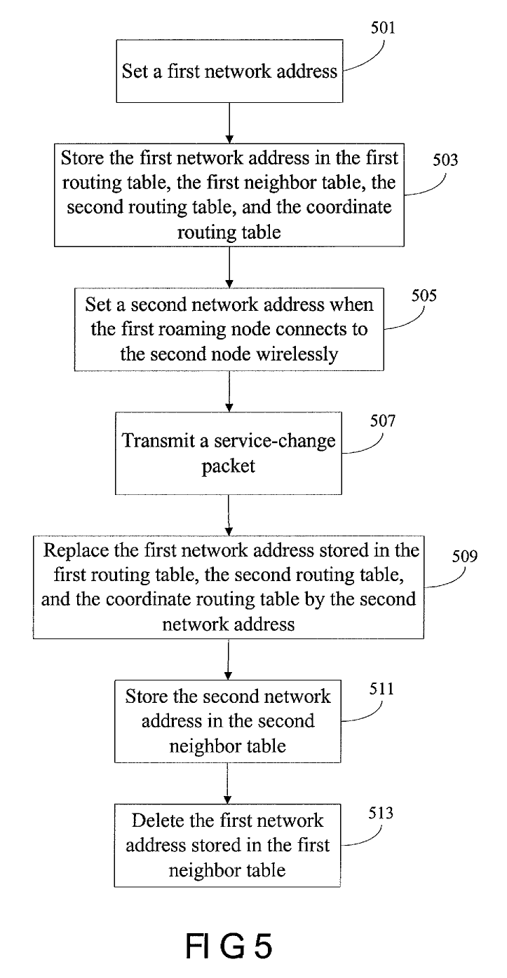

As shown in FIG. 5, the method further comprises the following steps. In step 501, the first node sets a first network address when the first roaming node initially connects to the first node wirelessly. In step 503, the first network address is stored in the first routing table, the first neighbor table, the second routing table, and the coordinate routing table. When the coordinator comprises a binding table, the first network address is also stored in the binding table. In step 505, when the first roaming node roams within a connecting range of the second node and connects to the second node wirelessly, the first roaming node has connected to the second node after step 401 to step 409 have been executed, and the second node sets a second network address of the first roaming node. In step 507, the second node transmits a service-change packet to the first node and the coordinator. In step 509, the first network address that is stored in the first routing table, the second routing table, and the coordinate routing table is replaced by the second network address respectively. If the coordinator comprises the binding table, the first network address that is stored in the binding table is also replaced by the second network address. The tables are updated immediately by the above steps. In step 511, the second network address is stored in the second neighbor table. In step 513, the first network address stored in the first neighbor table is deleted.

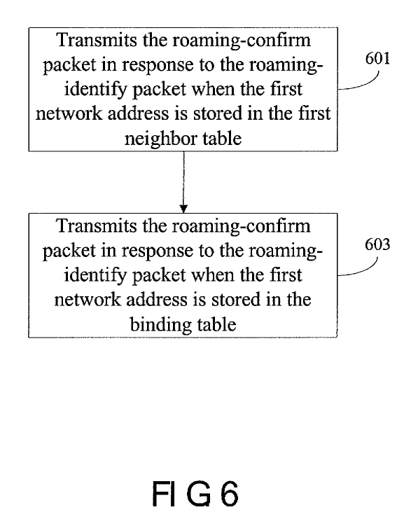

For further explaining how the first node or the coordinator can transmit the roaming-confirm packet in step 405, the method of the second embodiment comprises the following steps as shown in FIG. 6. In step 601, when the first network address is stored in the first neighbor table, the first node transmits the roaming-confirm packet to the second node in response to the roaming-identify packet. In step 603, when the first network address is stored in the binding table, the coordinator transmits the roaming-confirm packet to the second node in response to the roaming-identify packet.

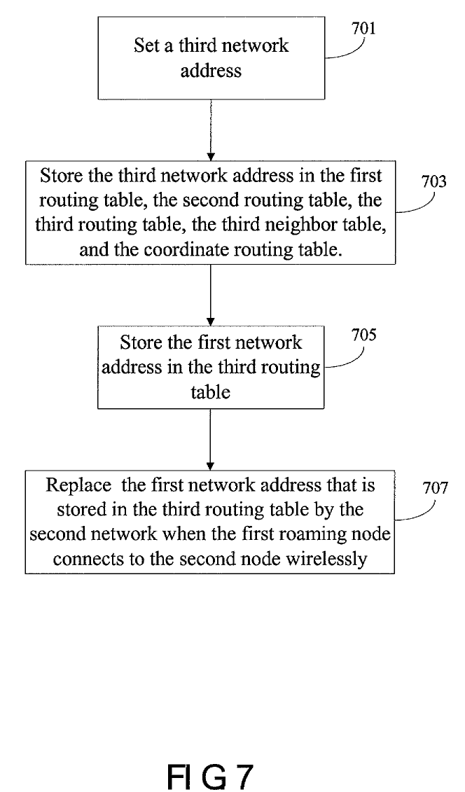

In the method of the second embodiment, the ZigBee network system further comprises a third node and a second roaming node, the third node and the coordinator are connected directly or indirectly. The second roaming node connects to the third node wirelessly. The third node further comprises a third routing table and a third neighbor table. As shown in FIG. 7, the method further comprises the following steps. In step 701, the third node sets a third network address for the second roaming node. In step 703, the third network address is stored in the first routing table, the second routing table, the third routing table, the third neighbor table, and the coordinate routing table. When the coordinator comprises a binding table, the third network address is also stored in the binding table. In step 705, when the first roaming node initially connects to the first node wirelessly, as disclosed in step 501, the third node stores the first network address in the third routing table. In step 707, after the step 409 is executed, the first roaming node roams within a connecting range of the second node and connects to the second node wirelessly. The third node replaces the first network address that is stored in the third routing table by the second network address to update the third routing table immediately.

In the ZigBee network system 2 as disclosed in the first embodiment, the roaming-request packet, the roaming-identify packet, the roaming-confirm packet, the roaming-response packet, and the service-change packet of the method of the second embodiment are transmitted via the network layer that is defined by the ZigBee standard.

The above methods can be implemented by using a computer program product, which stores a computer program to execute the aforesaid steps. The computer program product can be a floppy disk, a hard disk, an optical disc, a flash disk, a tape, a network accessible database or a storage medium with the same functionality which can be easily thought by people skilled in the field.

A third embodiment of the present invention is a router applied in a ZigBee network system with roaming function. The router may perform all of the operations and functions of the second node recited in the first embodiment. The details will not be repeated accordingly.

A forth embodiment of the present invention is an end device for using in a ZigBee network system with roaming function, The end device may perform all of the operations and functions of the first roaming node recited in the first embodiment. The details will not be repeated accordingly.

Accordingly, the present invention may improve defects of the ZigBee personal area network of the prior art. After the end device disconnects from the original connecting router, it can use a sequence of packets transmission to automatically connect other routers in the ZigBee network system, change the original network address of the end device, and redefine a routing path of data packets of the end device. Then the issues of the roaming function and the data packets that could not route smoothly in the prior art can be solved and improved without modifying the original structure.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A ZigBee network system with roaming function, comprising:
a first node;
a second node;
a coordinator, connecting to the first node and the second node directly or indirectly; and
a first roaming node, connecting to the first node wirelessly, the first roaming node transmitting a roaming-request packet to the second node when the first roaming node roams within a connecting range of the second node, the second node transmitting a roaming-identify packet to the first node and the coordinator in response to the roaming-request packet, the second node transmitting a roaming-response packet to the first roaming node in response to a roaming-confirm packet when one of the first node and the coordinator transmits the roaming-confirm packet to the second node in response to the roaming-identify packet, the first roaming node connecting to the second node wirelessly after it receives the roaming-response packet.

2. The ZigBee network system as claimed in claim 1, wherein the first node further comprises a first routing table, the second node further comprises a second routing table, and the coordinator further comprises a binding table, when the first roaming node connects to the first node wirelessly, the first node sets a first network address according to the first roaming node, and stores the first network address in the first routing table, the second routing table, and the binding table, when the first roaming node roams within the connecting range of the second node and connects to the second node wirelessly, the second node sets a second network address according to the first roaming node, and replaces the first network address stored in the first routing table, the second routing table, and the binding table by the second network address.

3. The ZigBee network system as claimed in claim 2, wherein the first node further comprises a neighbor table, the first node transmits the roaming-confirm packet to the second node in response to the roaming-identify packet when the first network address is stored in the neighbor table.

4. The ZigBee network system as claimed in claim 2, wherein the coordinator transmits the roaming-confirm packet to the second node in response to the roaming-identify packet when the first network address is stored in the binding table.

5. The ZigBee network system as claimed in claim 2, further comprising:
a third node, comprising a third routing table for connecting to the coordinator directly or indirectly; and
a second roaming node, connecting to the third node wirelessly, the third node setting a third network address according to the second roaming node, and storing the third network address in the first routing table, the second routing table, the third routing table, and the binding table, when the first roaming node connects to the first node wirelessly, the first network address being stored in the third routing table, when the first roaming node roams within the connecting range of the second node and connects to the second node wirelessly, the first network address stored in the third routing table being replaced by the second network address.

6. The ZigBee network system as claimed in claim 1, wherein the roaming-request packet, the roaming-identify packet, the roaming-confirm packet, and the roaming-response packet are transmitted via a Network Layer defined by a ZigBee standard.

7. A method for performing roaming function in a ZigBee network system, the ZigBee network system comprising a first node, a second node, a coordinator, and a first roaming node, the first roaming node connecting to the first node wirelessly, the first node, the second node, and the coordinator being connected directly or indirectly, the method comprising the steps of:
transmitting a roaming-request packet by the first roaming node when the first roaming node roams within a connecting range of the second node;
transmitting a roaming-identify packet by the second node in response to the roaming-request packet;
transmitting a roaming-confirm packet by one of the first node and the coordinator in response to the roaming-identify packet;
transmitting a roaming-response packet by the second node in response to the roaming-confirm packet; and
connecting to the second node wirelessly after the first roaming node receives the roaming-response packet.

8. The method as claimed in claim 7, wherein the first node comprises a first routing table, the second node comprises a second routing table, and the coordinator comprises a binding table, the method further comprising the steps of:
setting a first network address by the first node when the first roaming node connects to the first node wirelessly;
storing the first network address in the first routing table, the second routing table, and the binding table;
setting a second network address by the second node when the first roaming node connects to the second node wirelessly; and
replacing the first network address with the second network address.

9. The method as claimed in claim 8, wherein the ZigBee network system further comprises a third node and a second roaming node, the third node comprising a third routing table and connecting to the coordinator directly or indirectly, the second roaming node connecting to the third node wirelessly, the method further comprising the step of:
setting a third network address by the third node;
storing the third network address in the first routing table, the second routing table, the third routing table, and the binding table;
storing the first network address in the third routing table when the first roaming node connects to the first node wirelessly; and
replacing the first network address stored in the third routing table with the second network address when the first roaming node connects to the second node wirelessly.

10. The method as claimed in claim 7, wherein the roaming-request packet, the roaming-identify packet, the roaming-confirm packet, and the roaming-response packet are transmitted via a Network Layer defined by a ZigBee standard.

11. A computer program product for storing a computer program to execute a method for performing roaming function in a ZigBee network system, the ZigBee network system comprising a first node, a second node, a coordinator, and a first roaming node, the first roaming node connecting to the first node wirelessly, the first node, the second node, and the coordinator being connected directly or indirectly, the computer program comprising:
code for transmitting a roaming-request packet by the first roaming node when the first roaming node roams within a connecting range of the second node;
code for transmitting a roaming-identify packet by the second node in response to the roaming-request packet;
code for transmitting a roaming-confirm packet by one of the first node and the coordinator in response to the roaming-identify packet;
code for transmitting a roaming-response packet by the second node in response to the roaming-confirm packet; and
code for connecting to the second node after the first roaming node receives the roaming-response packet.

12. The computer program product as claimed in claim 11, wherein the first node comprises a first routing table, the second node comprises a second routing table, and the coordinator comprises a binding table, the computer program further comprising:
code for setting a first network address by the first node when the first roaming node connects to the first node wirelessly;
code for storing the first network address in the first routing table, the second routing table, and the binding table;
code for setting a second network address by the second node when the first roaming node connects to the second node wirelessly; and
code for replacing the first network address with the second network address.

13. The computer program product as claimed in claim 12, wherein the ZigBee network system further comprises a third node and a second roaming node, the third node comprising a third routing table and connecting to the coordinator directly or indirectly, the second roaming node connecting to the third node wirelessly, the computer program further comprising:
code for setting a third network address by the third node;
code for storing the third network address in the first routing table, the second routing table, the third routing table, and the binding table;
code for storing the first network address in the third routing table when the first roaming node connects to the first node wirelessly; and
code for replacing the first network address stored in the third routing table with the second network address when the first roaming node connects to the second node wirelessly.

14. The computer program product as claimed in claim 11, wherein the roaming-request packet, the roaming-identify packet, the roaming-confirm packet, and the roaming-response packet are transmitted via a Network Layer defined by a ZigBee standard.

15. A router for using in a ZigBee network system with roaming function, the ZigBee network system comprising a roaming node and a coordinator, the router connecting to the coordinator, when the roaming node roams within a connecting range of the router, the router receiving a roaming-request packet transmitted from the roaming node, and transmitting a roaming-identify packet to the coordinator in response to the roaming-request packet, when the coordinator transmits a roaming-confirm packet to the router in response to the roaming-identify packet, the router transmitting a roaming-response packet to the roaming node in response to the roaming-confirm packet and connecting to the roaming node wirelessly.

16. The router as claimed in claim 15, wherein the ZigBee network system further comprises a node, the node comprising a neighbor table, the router transmitting the roaming-identify packet to the node in response to the roaming-request packet, when an network address of the roaming node is stored in the neighbor table, the node transmitting the roaming-confirm packet to the router, and the router transmitting a roaming-response packet to the roaming node in response to the roaming-confirm packet and connecting to the roaming node wirelessly.

17. The router as claimed in claim 15, wherein the coordinator further comprises a binding table, when an network address of the roaming node is stored in the binding table, the coordinator transmits the roaming-confirm packet to the router, and the router transmits a roaming-response packet to the roaming node in response to the roaming-confirm packet and connects to the roaming node wirelessly.

18. The router as claimed in claim 15, wherein the roaming-request packet, the roaming-identify packet, the roaming-confirm packet, and the roaming-response packet are transmitted via a Network Layer defined by a ZigBee standard.

19. An end device for using in a ZigBee network system with roaming function, the ZigBee network system comprising a router and a coordinator, the router connecting to the coordinator, when the end device roams within a connecting range of the router, the end device transmitting a roaming-request packet to the router, and the router transmitting a roaming-identify packet to the coordinator in response to the roaming-request packet, when the coordinator transmits a roaming-confirm packet to the router in response to the roaming-identify packet, the end device receiving a roaming-response packet transmitted in response to the roaming-confirm packet from the router and connecting to the router wirelessly.

20. The end device as claimed in claim 19, wherein the roaming-request packet, the roaming-identify packet, the roaming-confirm packet, and the roaming-response packet are transmitted via a Network Layer defined by a ZigBee standard.
